(19) United States
(12) Patent Application Publication
(10) Pub. No.: US 2012/0105805 A1
(43) Pub. Date: May 3, 2012

(54) IMAGE VIEWING SYSTEMS WITH CURVED SCREENS

(76) Inventors: Huei Pei Kuo, Cupertino, CA (US); Alexandre M. Bratkovski, Mountain View, CA (US)

(21) Appl. No.: 12/917,368

(22) Filed: Nov. 1, 2010

(51) Int. Cl. G03B 21/14; G03B 21/60; G02B 27/22

(52) U.S. Cl. 353/7; 353/94

(57) ABSTRACT

This disclosure is directed to image viewing systems. In one aspect, an image viewing system includes a curved screen with a concave viewing surface, and an array of projectors. Each projector is positioned to project a different image onto the viewing surface from a different angle and the viewing surface is to reflect each image to a different viewing area with a horizontal scattering angle that defines the size of each viewing area. A viewer located in at least one viewing area is to receive a reflected image that enters one or both of the viewer's eyes when the viewer looks at the viewing surface.

### TECHNICAL FIELD

This disclosure relates to multiview and three-dimensional display technology.

### BACKGROUND

In recent years, the advent of stereo display technologies enabling viewers to view objects in three-dimensions with two-dimensional displays has been gaining interest and acceptance. With typical stereo display technology, viewers are required to wear eye glasses that control the visual content delivered to each eye. However, it is typically the case that the relative orientations of the projections received by the viewer are correct only for certain viewing locations, such as locations where a viewer's view is orthogonal to the center of a display. By contrast, viewers watching the same display outside these viewing locations experience a re-projection error that manifests as a vertical misalignment of the visual content received by the eyes of the viewers. If the images are very different, then in some cases one image at a time may be seen, a phenomenon known as binocular rivalry. Another type of visual artifact in typical stereo display technologies is that foreground and background objects often appear with the same focus.

However, a typical three-dimensional display often yields distortions in images of three-dimensional structures when compared with the real scenes as a result of displaying three-dimensional images on a single two-dimensional surface. For example, focusing cues such as accommodation and blur in a retinal image specify the depth of the display rather than the depth of the objects in the images displayed. Moreover, typical three-dimensional displays produce three-dimensional images by uncoupling vergence and accommodation, which often reduces a viewer's ability to effectively combine stereo image pairs and may cause viewer discomfort and fatigue. Thus, a mere below threshold objectionableness may not be sufficient for permitting the presence of such artifacts.

Designers and manufacturers of three-dimensional display systems continue to seek systems and methods that reduce the adverse effects associated with typical stereo display technology.

### BRIEF DESCRIPTION OF THE DRAWINGS

FIG. 1A shows a top perspective view, schematic representation of an example image viewing system.

FIG. 1B shows a top view of a screen and array of projectors of an example image viewing system.

FIG. 2 shows a top view of an example screen with a portion of the screen viewing surface magnified to reveal the viewing surface microstructures.

FIGS. 3A-3B show top and side views, respectively, of an example screen and a projector of a image viewing system.

FIGS. 4A-4D show four example microstructure groove patterns of viewing surfaces at the same magnification.

FIG. 5 shows examples of four different cross-sectional views of reflected beams of light associated with the groove patterns shown in FIGS. 4A-4B.

FIG. 6 shows a top view, schematic representation of an example image viewing system.

FIG. 7 shows a top view, schematic representation of an example image viewing system.

FIGS. 8A-8B show a top view, schematic representation of an example image viewing system.

FIG. 9 shows an example array of twenty-five perspective views created by an image viewing system.

### DETAILED DESCRIPTION

This disclosure is directed to image viewing systems. The image viewing systems can be used to display multiple two-dimensional views of a scene or motion picture. Each two-dimensional view can be viewed from a different viewing area. The image viewing systems can also be used to create a perceived continuous three-dimensional viewing experience of a scene or motion picture with correct perspective views and without viewers having to wear glasses or goggles to control the image input to each eye.

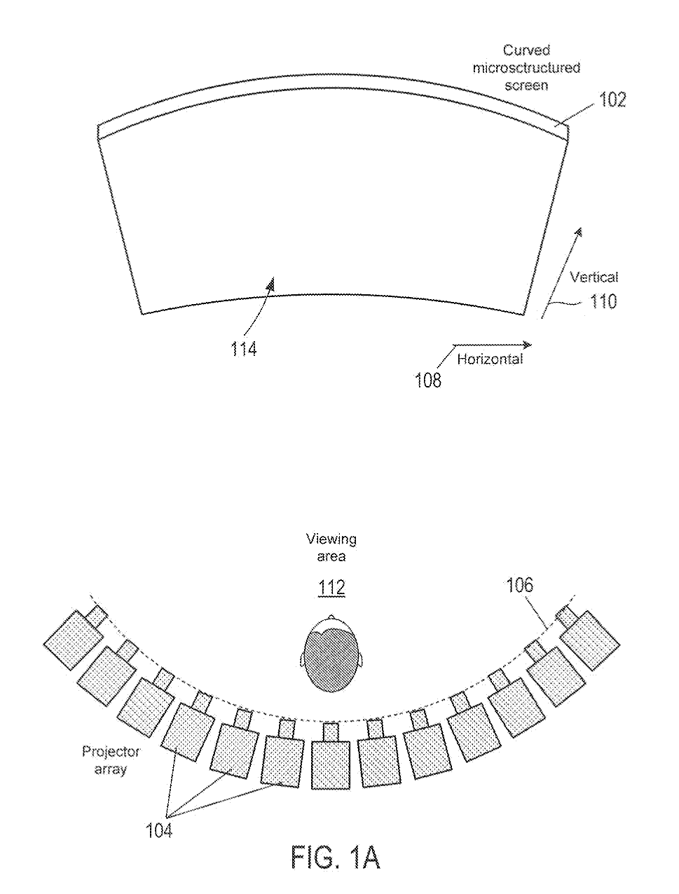

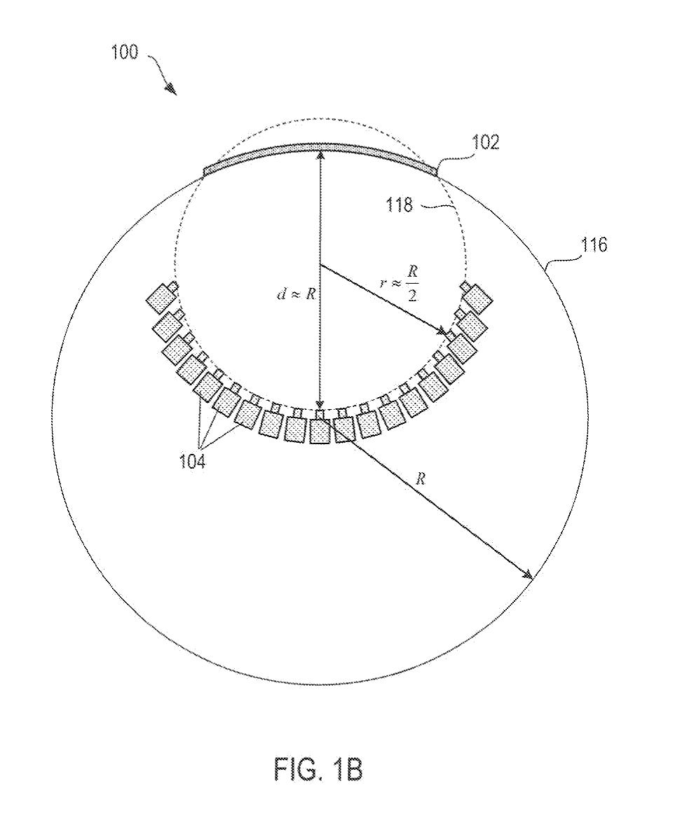

FIG. 1A shows a birds-eye perspective view of an example image viewing system 100. The system 100 includes a curved screen 102 and an array of projectors 104 arranged along an arc 106 of a circle. As shown in the example of FIG. 1, the screen 102 is curved in the horizontal direction 108 and straight in the vertical direction 110 with respect to a viewing area 112 to form a concave viewing surface 114. The horizontal direction 108 is parallel to the view area 112 and the vertical direction 110 is perpendicular to the viewing area 112. The projectors 104 each project onto the concave viewing surface 114 of the screen 102. The concave viewing surface 114 is curved in the horizontal direction 108 to match a portion of the curved outer surface of a cylinder. In other examples, the concave viewing surface can be curved to match a portion of the curved outer surface of a sphere, paraboloid, an ellipsoid, or any other suitable shape that creates a concave-like viewing surface.

FIG. 1B shows a top view of the screen 102 and the array of projectors 104. Large circle 116 is the perimeter of a planar surface of a cylinder, or sphere, with a radius R, and the arc 106 (shown in FIG. 1A) is a portion of the perimeter of a dashed-line circle 118 with a radius r≈R/2. As shown in FIG. 1B, a portion of the circle 118 is located outside of the larger circle 116. The average distance d of the projectors 104 to the center of the screen 102 is less than about R, and in certain example implementations can range from 2-3 meters. The screen 102 can be composed of stainless steel or a suitable plastic, such as polyoxymethylene, and the viewing surface 114, shown in FIG. 1A, includes microstructures. In other examples, the screen 102 can be composed of glass, polycarbonate, or another suitable transparent material with a microstructured viewing surface and the opposite surface coated with silver or aluminum to create a concave mirror. In an alternative example, the reflective material coats the viewing surface.

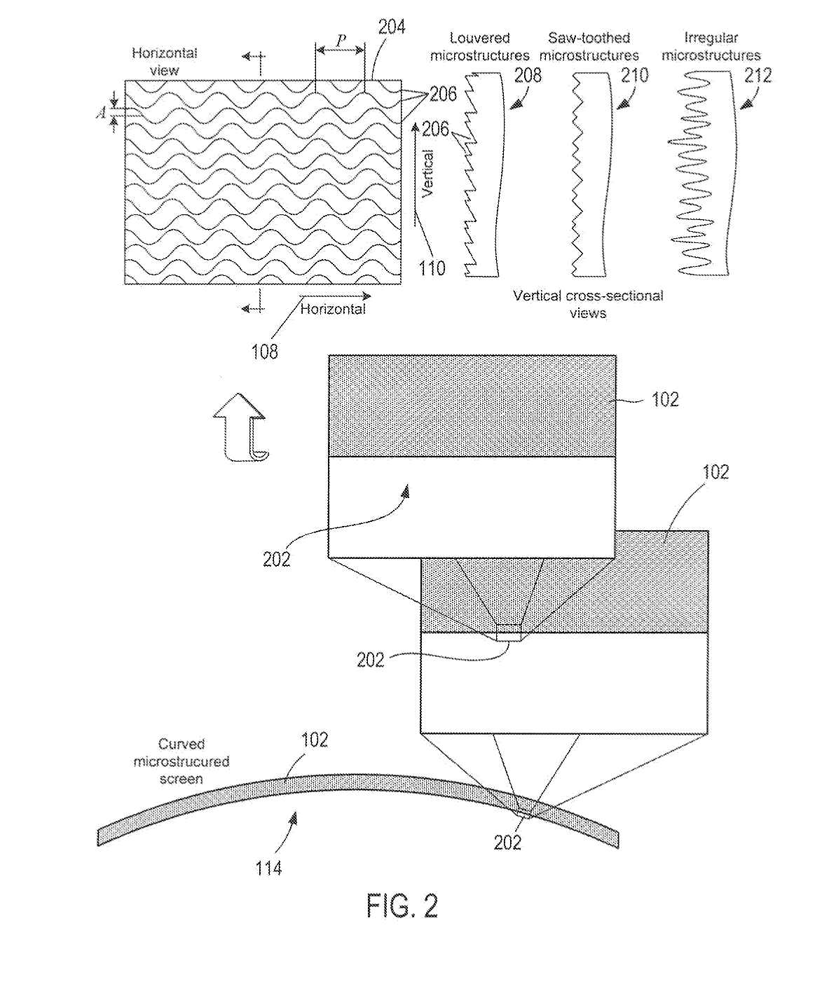

FIG. 2 shows a top view of the screen 102 with a portion 202 of the screen 102 viewing surface 114 magnified two times. FIG. 2 also shows a front view 204 of the portion 202 that reveals an example of one kind of microstructures that can form the viewing surface 114 of the screen 102. In the example of FIG. 2, the microstructures are a series of vertically spaced grooves 206 that extend with a sinusoidal-like wave pattern in the horizontal direction 108. The parameter P represents the period or the distance in the horizontal direction of any point along a groove to the next point along the same groove of corresponding phase, and the parameter A represents the amplitude of the groove sinusoidal-like wave pattern, where the parameters P and A can vary along the groove. FIG. 2 also includes cross-sectional views 208, 210, and 212 along a line I-I of just three kinds of example cross-sectional groove patterns. For example, cross-sectional view 208 reveals a louvered groove shape. In other words, the grooves 206 are slanted in cross-sectional view 208. Cross-sectional view 210 reveals saw-toothed or triangular-shaped grooves. Cross-sectional view 212 reveals an irregular groove pattern.

Note that in the example of FIG. 2, the grooves 206 arc randomly distributed in the horizontal direction 108. In practice, the grooves can also be arranged so that the troughs, or crests, of the grooves are aligned in the vertical direction 110. Alternatively, the grooves can be arranged so that troughs along one groove are aligned with the crests along an adjacent groove.

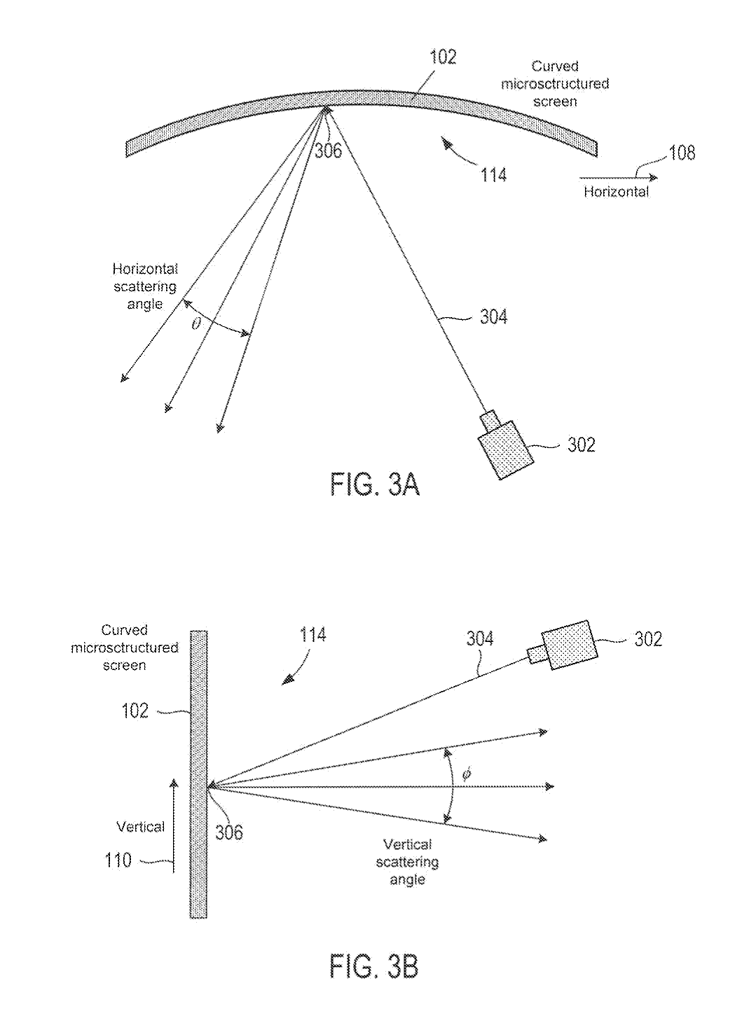

The period P and amplitude A of the grooves determine how light is scattered from the viewing surface 114 of the screen 102. FIGS. 3A-3B show top and side views, respectively, of the screen 102 and a projector 302. In the examples of FIGS. 3A-3B, the projector 302 generates a beam of light 304 that strikes the viewing surface 114 of the screen 102 at a point 306. A beam of light is reflected from the point 306 with a horizontal scattering angle θ, shown in FIG. 3A, and with a vertical scattering angle φ, shown in FIG. 3B. The larger the horizontal scattering angle θ the more diffuse the reflected beam of light appears in the horizontal direction 108. Likewise, the larger the vertical scattering angle φ the more diffuse the reflected beam of light appears in the vertical direction 110. The period P alone does not significantly affect the horizontal scattering angle, instead the ratio A/P and shape of groove cross-sectional pattern determines the scattering angles θ and φ.

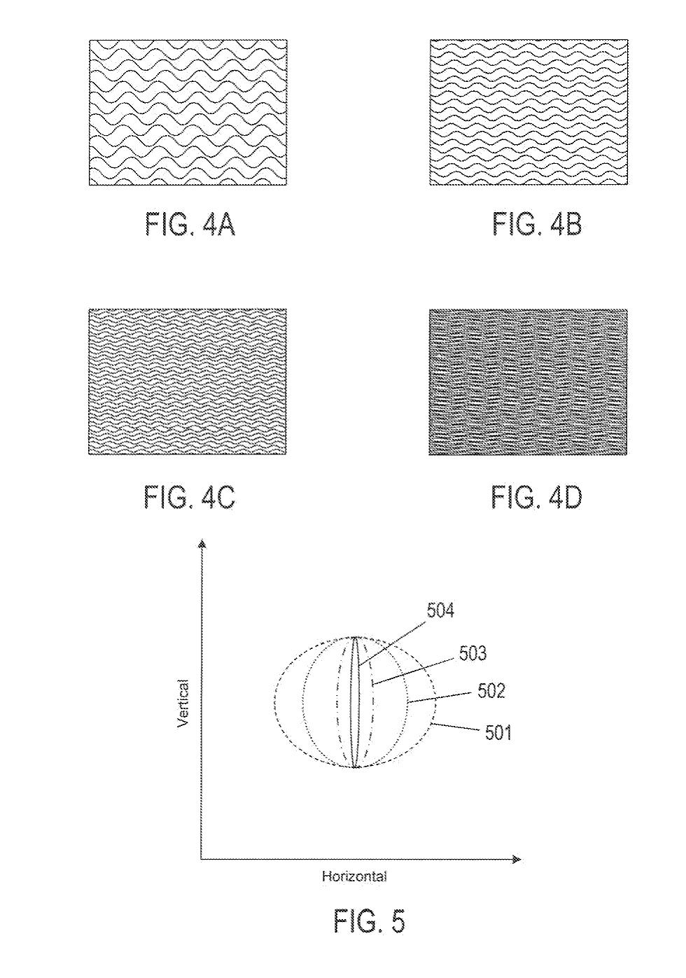

FIGS. 4A-4D show four example microstructure groove patterns of screen viewing surfaces at the same magnification. The period P and amplitude A decrease from the groove pattern shown in FIG. 4A to the groove pattern shown in FIG. 4D. In other words, the example groove pattern shown in FIG. 4A has the largest period and amplitude, while the groove pattern shown in FIG. 4D is composed of nearly linear approximately parallel grooves. The periods and amplitudes associated with the groove patterns in FIGS. 4B and 4C are intermediate to those shown in FIGS. 4A and 4D.

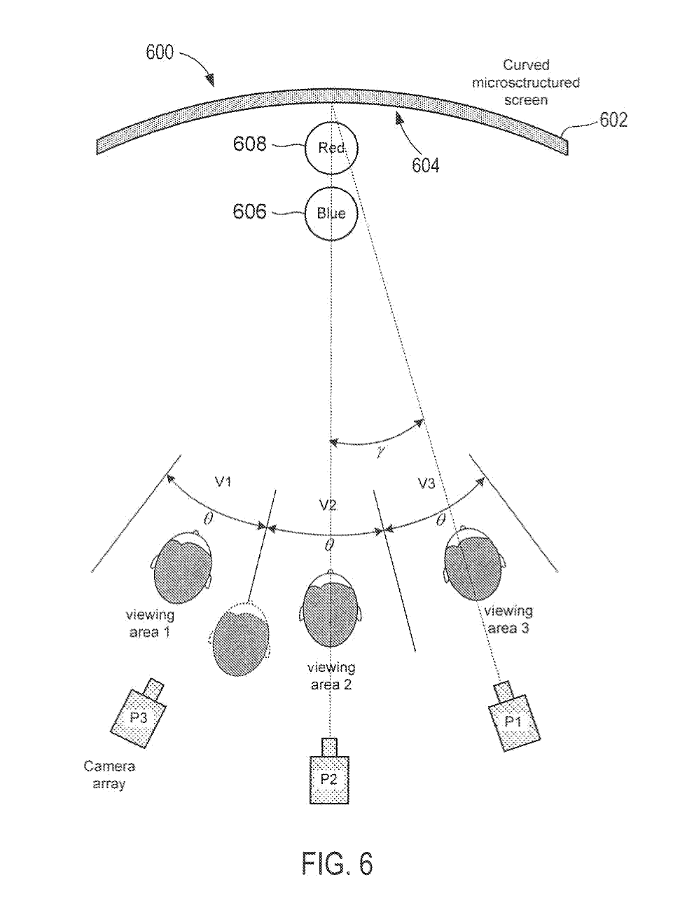

FIG. 5 shows examples of four different cross-sectional views of reflected beams of light associated with each of the groove patterns shown in FIGS. 4A-4B. The incident beams of light used to produce the example cross-sectional views have the same cross-sectional dimensions and strike the four surfaces at the same angle of incidence. The perimeter of each reflected beam cross section is identified by a different line pattern. Dashed-line oval 501 represents a reflected beam with the largest cross section reflected from a viewing surface with the groove pattern shown in FIG. 4A. Dotted-line oval 502 represents a reflected beam with the second largest cross section reflected from a viewing surface with the groove pattern shown in FIG. 4B. Dot-dashed oval 503 represents a reflected beam with the second smallest cross section reflected from a viewing surface with the groove pattern shown in FIG. 4C. Solid-line oval 504 represents a reflected beam with the smallest cross section reflected from a viewing surface with the groove pattern shown in FIG. 4D.

Note that in FIG. 5, the reflected beam cross sections reveal that the vertical dimension of the reflected beams remains unchanged. In other words, the vertical scattering angle φ is approximately the same for the different viewing surface microstructures. The vertical scattering angle is controlled by the groove cross-sectional pattern. FIGS. 4 and 5 also reveal that as the period P and amplitude A decrease, the horizontal scattering angles of the reflected beams also decrease. As a result, the screen 102 can be configured to limit the horizontal scattering angle θ of a reflected image by appropriately selecting the ratio A/P. For example, the horizontal scattering angle θ of a louvered plastic screen with A/P≈1 has a horizontal scattering angle of about 100°, a louvered plastic screen with A/P≈0.05 has a horizontal scattering angle of about 20°, a stainless steel screen A/P≈0 has a horizontal scattering angle considerable less than 1°. In an example implementation, the period P and the spacing between the grooves can be designed to be much smaller than the dimension a pixel on the display. For a high-definition screen, a pixel is approximately 0.5×0.5 mm², and the period P and spacing between adjacent grooves is less than approximately 0.1 mm.

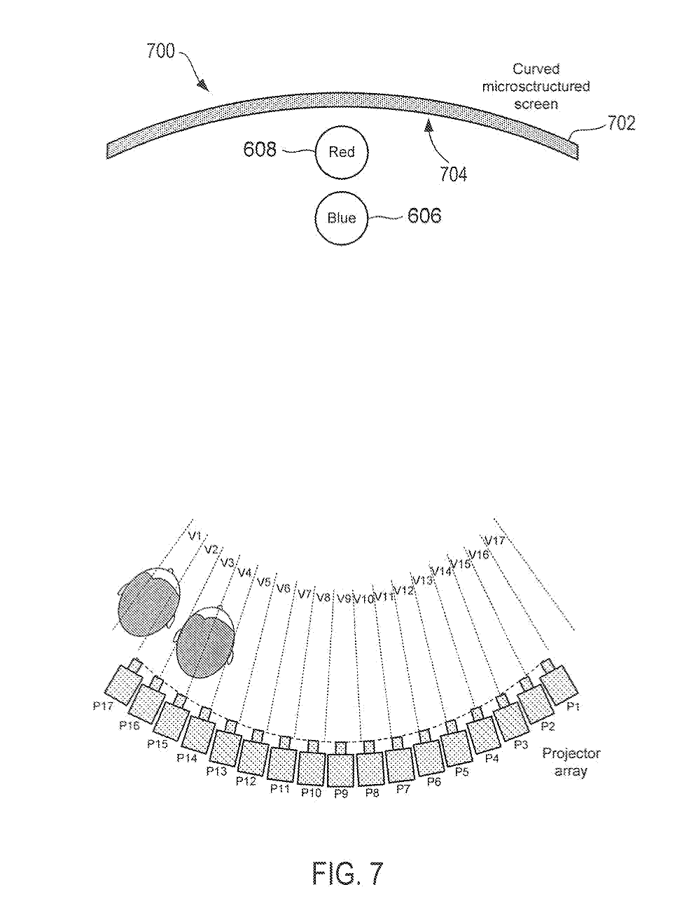

Control over the horizontal scattering angle θ enables the viewing surface to be configured to simultaneously reflect different images projected onto to the screen 102 to different viewing areas and can only be viewed from within a viewing area. For example, as described in greater detail below with reference to FIG. 6, a first viewer located in a first viewing area is able to view a first image projected onto the screen 102 from a first projector, and a second viewer located in a second viewing area is able to view a second image projected onto the screen 102 from a second projector. However, the first viewer is not able to view the second image from the first viewing area, and the second viewer is not able to view the first image from the second viewing area.

The screen 102 can be configured to operate as a multiview display that presents viewers located in different viewing areas with different two-dimensional views of the same scene, or different scenes, projected onto the screen 102. A multiview viewing experience is created using multiple projectors that each project a different image onto the viewing surface 114 of the screen 102. The viewing surface 114 of the screen 102 is configured so that the horizontal scattering angle θ is smaller than the angle of separation between the projectors in order to avoid overlap between adjacent views. For example, a viewer can be provided with a three-dimensional viewing experience of a scene by displaying different two-dimensional perspective views of the same scene on the screen 102 that can only be viewed from different viewing areas.

FIG. 6 shows a top view, schematic representation of an example image viewing system 600. The system 600 includes a curved screen 602 with a viewing surface 604 configured to provide a multiview viewing experience. The system 600 also includes three projectors identified as P1-P3. In order to create separate viewing areas identified as viewing areas 1-3 that enable a viewer located within a viewing area to see only the projected image from one of the projectors P1-P3, the viewing surface 604 is configured with a groove pattern that creates a horizontal scattering angle θ that is approximately equal to the angle of separation γ between adjacent projectors P1 and P2 and adjacent projectors P2 and P3. For example, three separate viewing areas may be created with the adjacent projectors located about 3 m from the screen 602 and separated by about 30°, and the viewing surface 604 configured with a groove pattern to create an approximately 20° horizontal viewing angle.

In the example of FIG. 6, the projectors P1-P3 each project one of three different perspective views of a blue ball 606 located in front of a red ball 608 denoted by V1, V2, and V3. The image of the blue and red balls 606 and 608 produced by projector P1 is viewable from viewing area 1, the image of the blue and red balls 606 and 608 produced by projector P2 is viewable from a central viewing area 2, and the image of the blue and red balls 606 and 608 produced by projector P3 is viewable from viewing area 3. A viewer located in viewing area 1 sees a two-dimensional perspective view V1 of the red ball 608 located to the left of, and occluded by, the blue ball 606. A viewer located in viewing area 2 sees a two-dimensional perspective view V2 of the blue ball 606 blocking the view of the red ball 608. A viewer located in viewing area 3 sees a two-dimensional perspective view V3 of the red ball 608 located to the right of, and occluded by, the blue ball 606. As shown in FIG. 6, a viewer straddling viewing areas 1 and 2 such that view V1 enters the viewer's left eye and view V2 enters the viewer's right eye may experience binocular rivalry because the perspective views in this example may be considerably different.

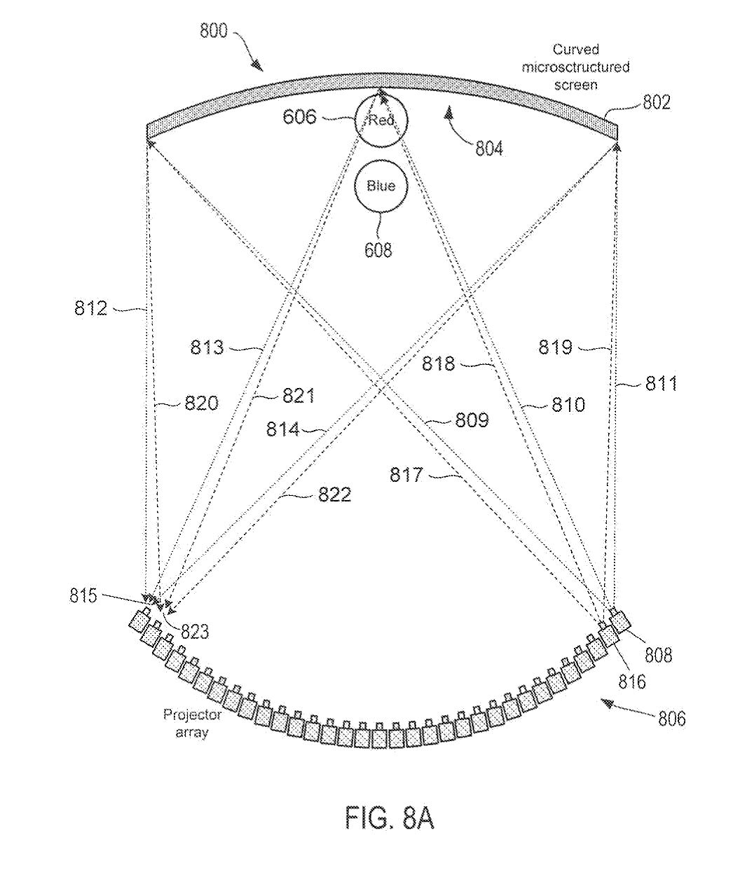

The number of multiview viewing areas can be increased by increasing the number of projectors that each project a different perspective view and by appropriately selecting the ratio A/P to narrow the horizontal scattering angle θ to produce narrower viewing areas. FIG. 7 shows a top view, schematic representation of an example image viewing system 700. The system 700 includes a curved screen 702 with a viewing surface 704 configured to provide a multiview viewing experience. The system 700 also includes an array of seventeen projectors denoted by P1-P17. In order to create seventeen separate viewing areas identified by dashed lines that enable a viewer located within a viewing area to see only the projected image from one of the projectors, the viewing surface 704 is configured with a groove pattern that creates a horizontal scattering angle θ that is approximately equal to the angle of separation between adjacent projectors.

In the example of FIG. 7, the projectors P1-P17 each project a different perspective view of the blue ball 606 located in front of a red ball 608. The system 700 is configured to project seventeen different two-dimensional perspective views of the same blue and red balls 606 and 608. The different perspective views are denoted by V1-V17 and correspond to projectors P1-P17, respectively. Each projector Pi projects different perspective view image Vi of the blue and red balls 606 and 608, where i is a positive integer between 1 and 17. By increasing the number of two-dimensional perspective views, a viewer can move from one viewing area to an adjacent viewing area and see two different perspective views, but without a significant, or abrupt, change in the perspective view. For example, consider a viewer located in a viewing area that enables the viewer to see perspective view V1. The perspective view V1 shows the red ball 608 located to the left of, and occluded by, the blue ball 606. When the viewer changes position to see perspective view V2, the viewer also sees the red ball 608 locate to the left of, and occluded by, the blue ball 606, but more of the red ball 608 is positioned behind the blue ball 606 in perspective view V2 than in perspective view V1. Unlike the three perspective views described above with reference to FIG. 6, the seventeen perspective views V1-V17 enable a viewer to move around in front of the screen 702 and see a near continuum of different two-dimensional perspective views.

FIG. 7 also shows a viewer's head straddling two adjacent viewing areas such that perspective view V3 enters the viewer's left eye and perspective view V4 enters the viewer's right eye. If the two-dimensional perspective views V3 and V4 are similar but slightly different perspective views of the same scene, the perspective views V3 and V4 may be perceived by the viewer as a stereo image pair, enabling the viewer to perceive a three dimensional perspective view image of the blue and red balls 606 and 608. On the hand, the viewer may experience visual rivalry if the perspective views V3 and V4 are sufficiently different.

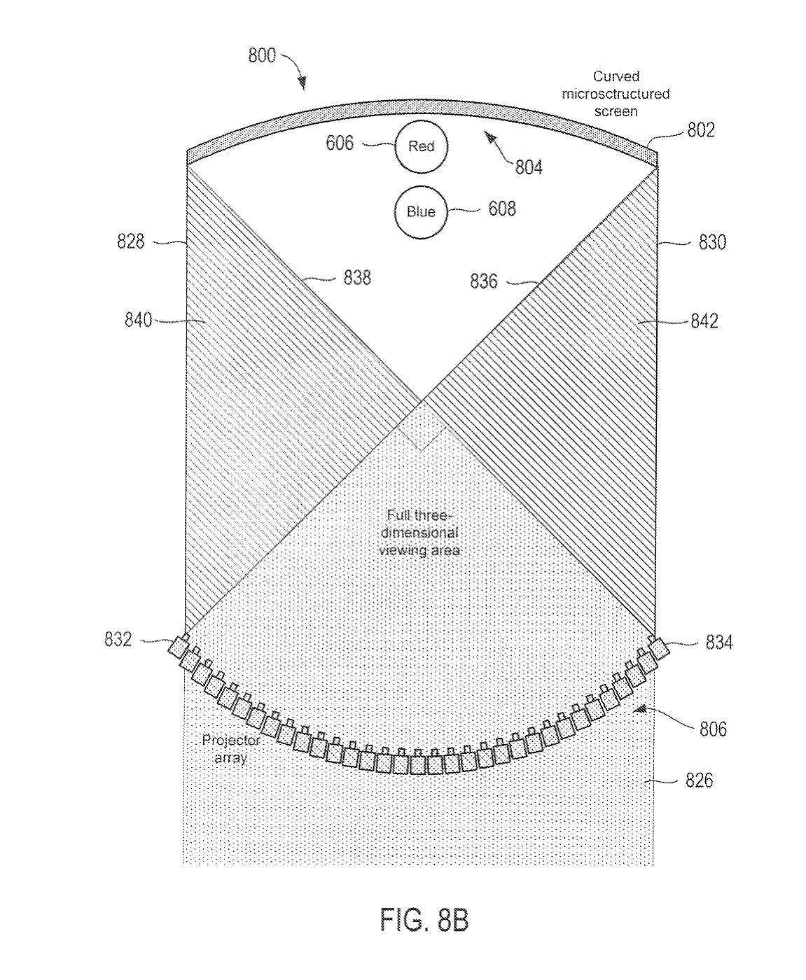

Further decreasing the horizontal scattering angle of the screen and increasing the number of two-dimensional perspective views of a scene or motion picture, creates a perceived continuous three-dimensional viewing experience of the scene or motion picture with correct perspective views. FIG. 8A shows a top view, schematic representation of an example image viewing system 800. The system 800 includes a curved screen 802 with a microstructured viewing surface 804. The system 800 also includes an array of thirty-three projectors 806. The viewing surface 804 is configured with a groove pattern that creates a horizontal scattering angle θ that is approximately equal to the angle of separation between adjacent projectors, as described above with reference to FIG. 6. In particular, the viewing surface 804 can be configured with grooves that reflect each image with a narrow horizontal scattering angle θ, as described above with reference to FIGS. 4-5. For example, the horizontal scattering angle θ may be significantly less than 1° (i.e., <<1°).

The projectors 806 each project a slightly different perspective view image of a scene or motion picture onto the viewing surface 804. The images projected by each of the projectors onto the viewing surface 804 are reflected back to the viewing area with a narrow horizontal scattering angle creating narrow adjacent viewing areas. For example, as shown in FIG. 8A, projector 808 projects a first image outlined by dotted-line directional arrows 809-811 onto the viewing surface 804. The first image is reflected off of the viewing surface 804 with a narrow horizontal scattering angle to a narrow first viewing area 815, as indicated by dotted-line directional arrows 812-814. Likewise, projector 816 projects a slightly different image outlined by dashed-line directional arrows 817-819 onto the viewing surface 804. The second image is reflected off of the viewing surface 804 with a narrow horizontal scattering angle to a narrow second viewing area 823 adjacent to the first viewing area 815, as indicated by dashed-line directional arrows 820-822. For example, consider a viewer with the left eye located in viewing area 815 and the right eye located in viewing area 823. The perspective view entering the viewer's left eye is of the red ball 608 located to the left of, and occluded by, the blue ball 606, and the perspective view entering the viewer's right eye is of the red ball 608 also located to the left of, and occluded by, the blue ball 606, but more of the red ball 608 is occluded by the blue ball 606 in the image entering the right eye than in the image entering the left eye. The two images form a stereo image pair and the viewer perceives a three-dimensional perspective view.

In order to create a perceived continuous three-dimensional viewing experience, each viewing area is narrower than the average distance between two human eye pupils (i.e., less than about 6 cm), so that each perspective view image enters one, but not both, of a viewer's eyes. The horizontally narrow viewing areas form a three-dimensional viewing area represented by shaded area 826, shown in FIG. 8B. The three-dimensional viewing area 826 is a space in which a viewer can move around and perceive a continuous three-dimensional, full screen viewing experience without having to wear glasses or goggles to control the image input to each eye. The three-dimensional viewing area 826 is defined by parallel lines 828 and 830 extending from the outside edges of the screen 102 to the projectors 832 and 834, respectively, located at the ends of the array of projectors 806, and by intersecting lines 836 and 838 extending from the outside edges of the screen 102 to the projectors 832 and 834, respectively. A viewer located outside the three-dimensional viewing area 826 sees only a portion of the full screen three-dimensional image. For example, a viewer located in shaded viewing area 840 sees only the left portion of the screen 802 in three-dimensions, and a person located in shaded viewing area 842 sees only the right portion of the screen 802 in three-dimensions.

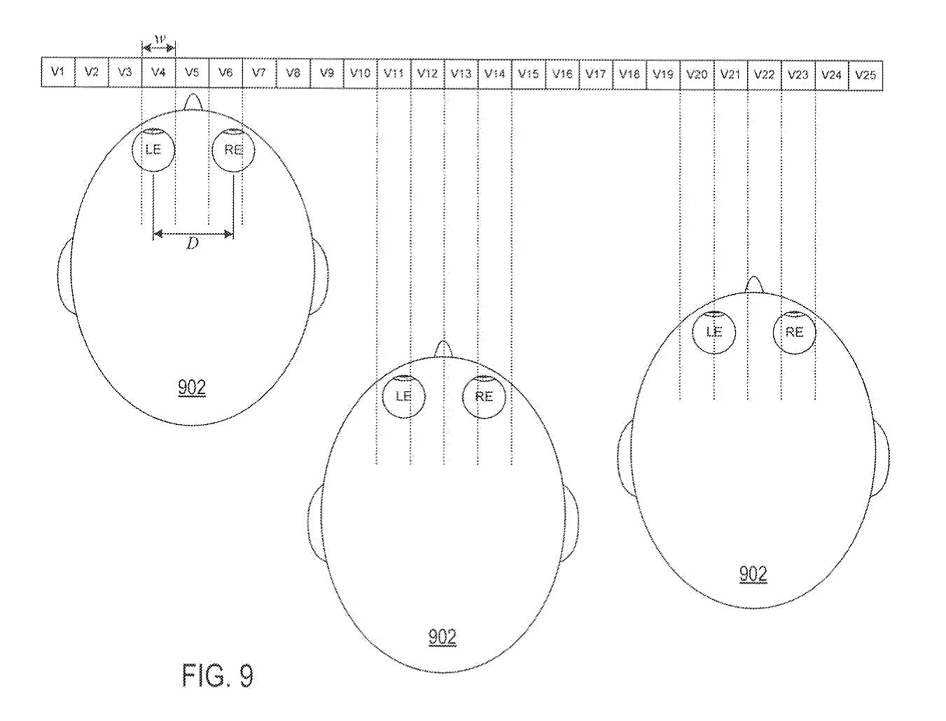

FIG. 9 shows an example array of twenty-five perspective views denoted by V1-V25 created by an image viewing system configured to create a perceived continuous three-dimensional viewing experience. Each perspective view is associated with a different viewing area and has a width w that is less than the distance D between a viewer's eyes (i.e., w<D). In the example of FIG. 9, the viewer 902 is positioned so that perspective view V4 enters the viewer's left eye LE and perspective view V6 enters the viewer's right eye RE. Even though the perspective views V4 and V6 are separated by perspective view V5, the perspective views V4, V5, and V6 are slightly different. As a result, the perspective views V4 and V6 are sufficient to operate as a stereo image pair that enables the viewer 902 to perceive a three dimensional perspective view of the scene or motion picture presented on the viewing system screen. In FIG. 9, the viewer 902 also changes position so that perspective view V11 enters the viewer's left eye LE and perspective view V14 enters the viewer's right eye RE. Even though the perspective views V11 and V14 are separated by two perspective views V12 and V13, the perspective views V11-V14 are slightly different. As a result, the perspective views V11 and V14 are sufficient to operate as a stereo image pair that enables the viewer 902 to perceive a three dimensional perspective view of the image presented on the viewing system screen. FIG. 9 also shows the viewer's LE straddling two different perspective views. Adjacent perspective views V20 and V21 both enter the viewer's left eye LE and perspective view V23 enters the viewer's right eye RE. Adjacent perspective views V20 and V21 overlap to a great extent. As a result, the viewer's brain averages the two adjacent views to produce a two-dimension perspective view that in combination with the perspective view V23 form a stereo image pair. Note that a person with only one good eye, or suffering from total three-dimensionally impaired vision, can still see three-dimensional perspective views by moving his/her head back and forth to create motion parallax.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. An image viewing system comprising:
a curved screen with a concave viewing surface; and
an array of projectors, wherein each projector is positioned to project a different image onto the viewing surface from a different angle of incidence and the viewing surface is to reflect each image to a different viewing area with a horizontal scattering angle that defines the size of each viewing area, and wherein a viewer located in at least one viewing area is to receive a reflected image that enters one or both of the viewer's eyes when the viewer looks at the viewing surface.

2. The system of clam 1, wherein the array of projectors have a concave arrangement that faces the screen.

3. The system of claim 1, wherein the concave viewing surface is curved to match a portion of the curved outer surface of a cylinder.

4. The system of claim 1, wherein the concave viewing surface is curved to match a portion of the curved outer surface of a sphere

5. The system of claim 1, wherein the concave viewing surface further comprises grooves with sinusoidal wave patterns that extend parallel to the viewing area.

6. The system of claim 1, wherein the concave viewing surface further comprises grooves with sinusoidal wave patterns with an amplitude to period ratio that determines the horizontal scattering angle of light reflected from the viewing surface.

7. The system of claim 1, wherein the array of projectors further comprises each pair of projectors are to project images onto the screen with an angle of separation that is approximately equal to the horizontal scattering angle of light reflected from the viewing surface.

8. The system of claim 1, wherein each different image further comprises a two-dimensional perspective view image of a scene or motion picture such that when the viewer is to look at the viewing surface from within a viewing area, a perspective view of the scene or motion picture is to enter both of the viewer's eyes.

9. The system of claim 1, wherein the viewing surface is to reflect each image to a different viewing area with a horizontal dimension that is less than the average distance between a viewer's eyes.

10. The system of claim 1, wherein each projector is to project a different perspective view image of a scene or motion picture onto the viewing surface and the viewing surface is to reflect each perspective view such that a first perspective view enters the viewer's left eye and a second perspective view enters the viewer's right eye to form a stereo image pair that is to provide the viewer with a three-dimensional, perspective view of the scene or motion picture.

11. A system for providing multiple perspective views comprising:
a screen with a microstructured viewing surface; and
an array of projectors, wherein each projector is positioned to project a different image onto the viewing surface from a different angle of incidence and the viewing surface is to reflect each image to a different viewing area with a horizontal scattering angle that defines the size of each viewing area, and wherein a viewer located in at least one viewing area is to receive a reflected image that enters one or both of the viewer's eyes when the viewer looks at the viewing surface.

12. The system of claim 11, wherein the array of projectors have a concave arrangement that faces the screen.

13. The system of claim 11, wherein the screen further comprises a concave viewing surface curved to match a portion of the curved outer surface of a cylinder.

14. The system of claim 11, wherein the screen further comprises a concave viewing surface curved to match a portion of the curved outer surface of a sphere

15. The system of claim 11, wherein the microstructured viewing surface further comprises grooves with sinusoidal wave patterns that extend parallel to the viewing area.

16. The system of claim 11, wherein the microstructured viewing surface further comprises grooves with sinusoidal wave patterns with an amplitude to period ratio that is to determine the horizontal scattering angle of light projected onto the viewing surface.

17. The system of claim 11, wherein the array or projectors further comprises each pair of projectors are to project images onto the screen with an angle of separation that is greater than the horizontal scattering angle of light reflected from the viewing surface.

18. The system of claim 11, wherein each different image further comprises a two-dimensional perspective view image of a scene or motion picture such that when the viewer is to look at the viewing surface from within a viewing area, a perspective view of the scene or motion picture is to enter both of the viewer's eyes.

19. The system of claim 11, wherein the viewing surface is to reflect each image to a different viewing area with a horizontal dimension that is less than the average distance between a viewer's eyes.

20. The system of claim 11, wherein each projector is to project a different perspective view image of a scene or motion picture onto the viewing surface and the viewing surface is to reflect each perspective view such that a first perspective view enters the viewer's left eye and a second perspective view enters the viewer's right eye to form a stereo image pair that is to provide the viewer with a three-dimensional, perspective view of the scene or motion picture.
